(19) United States
(12) Patent Application Publication
(10) Pub. No.: US 2026/0202775 A1
(43) Pub. Date: Jul. 16, 2026

(54) IMAGE FORMING APPARATUS

(71) Applicant: Takahiro Kojima, Mishima Shizuoka (JP)

(72) Inventor: Takahiro Kojima, Mishima Shizuoka (JP)

(73) Assignee: ETRIA Co., Ltd., Kanagawa (JP)

(21) Appl. No.: 19/449,283

(22) Filed: Jan. 14, 2026

(30) Foreign Application Priority Data
Jan. 16, 2025 (JP) 2025-006251

(51) Int. Cl. G03G 15/043; G03G 15/00; G03G 21/20

(52) U.S. Cl. CPC G03G 15/043; G03G 15/5004; G03G 15/502; G03G 15/5062; G03G 21/20

(57) ABSTRACT

According to an embodiment, an image forming apparatus includes a plurality of image forming units, an exposure unit, a transfer unit, and a processor. The processor is configured to, if a difference between an environmental temperature and a temperature in the exposure unit during a time from a start of activation to a start of image formation satisfies a predetermined condition, display, on a display device, a guidance to notify misalignment of each image that the transfer unit transfers to the medium after a predetermined guidance start time has elapsed from an activation operation.

### CROSS REFERENCE TO RELATED APPLICATIONS

This application is based upon and claims the benefit of priority from Japanese Patent Application No. 2025-006251, filed Jan. 16, 2025, the entire contents of which are incorporated herein by reference.

### FIELD

Embodiments described herein relate generally to an image forming apparatus.

### BACKGROUND

An electrophotographic type image forming apparatus implements color print by overlaying images formed using color toners. In such an image forming apparatus, an image misalignment (color misalignment) may occur in which the images of colors to be overlaid are misaligned. An example of the cause of the image misalignment is the displacement of each portion caused by the influence of a temperature change in an exposure device (optical scanning device). If the temperature change in the exposure device reaches a specific condition, the image forming apparatus executes position deviation correction (alignment) for correcting the image misalignment. In the conventional image forming apparatus, however, an image misalignment readily occurs even if the specific condition to execute position deviation correction is not reached after an activation operation.

### BRIEF DESCRIPTION OF THE DRAWINGS

FIG. 1 is a view showing an example of the configuration of each portion in an image forming apparatus according to an embodiment.

FIG. 2 is a plan view showing an example of the configuration of an exposure device in the image forming apparatus according to the embodiment.

FIG. 3 is a bottom view showing an example of the configuration of the exposure device in the image forming apparatus according to the embodiment.

FIG. 4 is a sectional perspective view showing an example of the configuration of the exposure device in the image forming apparatus according to the embodiment.

FIG. 5 is a view showing an example of installation of an environment sensor and dump heaters in the image forming apparatus according to the embodiment.

FIG. 6 is a block diagram showing an example of the configuration of a control system in the image forming apparatus according to the embodiment.

FIG. 7 is a view showing the first example indicating the relationship between the temperature change of each portion and color misalignment in the image forming apparatus according to the embodiment.

FIG. 8 is a view showing the second example indicating the relationship between the temperature change of each portion and color misalignment in the image forming apparatus according to the embodiment.

FIG. 9 is a flowchart for explaining an example of the operation of image misalignment guidance processing in the image forming apparatus according to the embodiment.

FIG. 10 is a view showing an example of display on an operation screen that includes a guidance of image misalignment displayed on the display unit of a control panel in the image forming apparatus according to the embodiment.

FIG. 11 is a view showing an example of display on the operation screen that includes a guidance of image misalignment displayed on the display unit of the control panel in the image forming apparatus according to the embodiment.

### DETAILED DESCRIPTION

According to an embodiment, an image forming apparatus includes a plurality of image forming units, an exposure unit, a transfer unit, and a processor. Each of the plurality of image forming units forms an image by developing a latent image formed on a photosensitive member using a developing agent supplied to the image forming unit. The exposure unit outputs light for forming the latent image on the photosensitive member in each of the plurality of image forming units. The transfer unit overlays the plurality of images that the plurality of image forming units have developed by the developing agent and transfers the images to a medium. If the difference between the environmental temperature and the temperature in the exposure unit from the start of activation to the start of image formation satisfies a predetermined condition, after a predetermined guidance start time has elapsed from the activation operation, the processor displays, on a display device, a guidance for notifying the misalignment of each image to be transfers to the medium by the transfer unit.

An image forming apparatus according to the embodiment will now be described with reference to the accompanying drawings.

Note that in the drawings to be used to explain the embodiment below, the scale of portions is sometimes changed as needed. Also, in the drawings to be used to explain the embodiment below, components are not illustrated in some cases for the descriptive convenience.

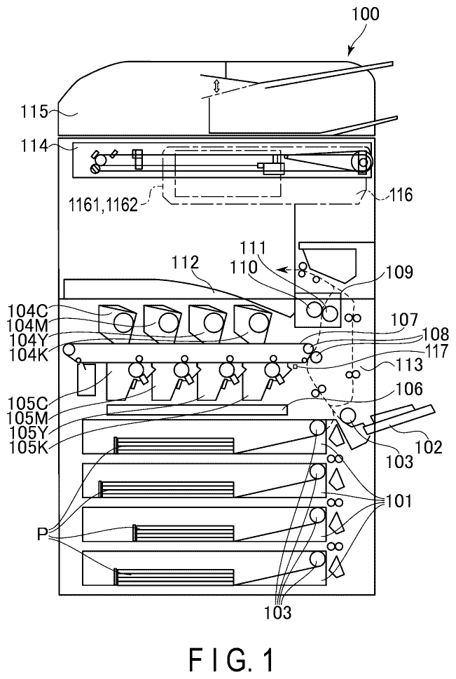

FIG. 1 is a view schematically showing an example of the configuration of an image forming apparatus 100 according to the embodiment. The image forming apparatus 100 is arranged in a workplace or the like. The image forming apparatus 100 performs print by an electrophotographic method. The image forming apparatus 100 is, for example, an MFP (multifunction peripheral), a copying machine, a printer, or a facsimile apparatus.

As shown in FIG. 1, the image forming apparatus 100 includes a paper feed tray 101, a manual feed tray 102, a paper feed roller 103, a toner cartridge 104, an image forming unit (image forming station) 105, an exposure device (exposure unit) 106, a transfer belt 107, a transfer roller 108, a fixing unit 109, a heating unit 110, a pressurizing roller 111, a discharge tray 112, a double-sided unit 113, a scanner 114, a document feed device 115, a control panel 116, and the like.

The image forming unit 105 prints an image by the electrophotographic method. The image forming unit 105 forms an image to be printed on an image formation medium P or the like using toner. The image formation medium P is, for example, sheet-like paper (paper sheet). The scanner 114 reads an image from an original with an image formed thereon. For example, the image forming apparatus 100 implements copy of the image of an original by printing the image that the scanner 114 reads from the original on the image formation medium (to be referred to as a paper sheet hereinafter) P by the image forming unit 105.

The paper feed tray 101 stores the paper sheet P as an image formation medium to be used for print. The manual feed tray 102 is a table used to manually feed the paper sheet P. The paper feed roller 103 rotates according to the action of a motor, thereby extracting the paper sheet P stored in the paper feed tray 101 or the manual feed tray 102 and supplying it to a conveyance path. In the image forming apparatus 100, a conveyance path for a paper sheet is formed by a plurality of rollers, and the like. The paper sheet P extracted by the paper feed roller 103 is supplied, through the conveyance path, to a transfer position (secondary transfer position) where an image is transferred.

The image forming apparatus 100 includes a plurality of toner cartridges 104. The toner cartridges 104 supply toners to the image forming units 105. In the configuration example shown in FIG. 1, the image forming apparatus 100 includes four toner cartridges including a toner cartridge 104C, a toner cartridge 104M, a toner cartridge 104Y, and a toner cartridge 104K. The toner cartridge 104C, the toner cartridge 104M, the toner cartridge 104Y, and the toner cartridge 104K store toners corresponding to CMYK (cyan, magenta, yellow, and black (key)) colors, respectively.

Note that the colors of the toners stored in the toner cartridges 104 are not limited to the CMYK colors and may be other colors. Also, the toner stored in the toner cartridge 104 may be special toner. For example, the toner cartridge 104 may store decolorable toner that is decolored to an invisible state at a temperature higher than a predetermined temperature.

The image forming apparatus 100 includes a plurality of image forming units 105. In the example shown in FIG. 1, the image forming apparatus 100 includes four image forming units 105 including an image forming unit 105C, an image forming unit 105M, an image forming unit 105Y, and an image forming unit 105K. The image forming unit 105C, the image forming unit 105M, the image forming unit 105Y, and the image forming unit 105K receive the supplied toners corresponding to the CMYK colors, respectively, and form toner images (images) of the colors.

Each image forming unit 105 includes a developer and a photosensitive drum (photosensitive member). An electrostatic latent image is formed on the surface of the photosensitive drum. The developer develops the electrostatic latent image formed on the surface of the photosensitive drum using the toner supplied from the toner cartridge 104. Thus, a toner image formed by the toner of the color is formed on the surface of the photosensitive drum of each image forming unit 105. Each image forming unit 105 includes a transfer unit. Each image forming unit 105 transfers (primary-transfers) the toner image formed on the surface of the photosensitive drum onto the transfer belt 107 at the transfer position (primary transfer position).

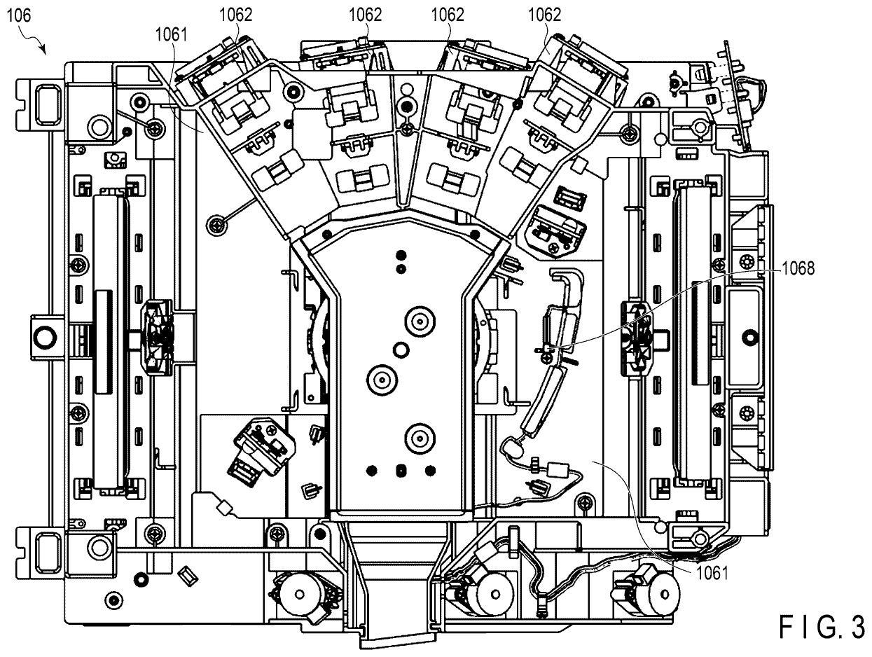

The exposure device 106 is also called an LSU (laser scanning unit) or the like. The exposure device 106 forms an electrostatic latent image on the surface of the photosensitive drum of each image forming unit 105 by a laser beam controlled in accordance with image data. The exposure device 106 is configured, for example, as shown in FIGS. 3, 4, and 5 to be described later.

The transfer belt 107 is, for example, an endless belt supported by rollers. The transfer belt 107 is configured to have a predetermined length in one round. The transfer belt 107 rotates according to the action of a motor. Along with the rotation of the transfer belt 107, images are transferred (primary-transferred) by the transfer rollers (primary transfer rollers) of the image forming units 105C, 105Y, 105M, and 105K. The transfer belt 107 conveys the images (toner images) transferred from the image forming units 105C, 105Y, 105M, and 105K to the position (secondary transfer position) of the transfer roller 108.

The transfer roller 108 includes two rollers facing each other. The transfer roller 108 transfers (secondary-transfers) the image formed on the transfer belt 107 to the image formation medium P passing between the transfer rollers 108.

The toner sensor 117 detects toner adhered to the transfer belt 107. The toner sensor 117 detects the toner image on the transfer belt 107 between the transfer position (primary transfer position) of the image forming unit 105K and a position (secondary transfer position) where the toner image on the transfer belt 107 corresponds to the transfer roller 108. For example, the toner sensor 117 is arranged to face the transfer belt 107 between the transfer roller (transfer unit) of the image forming unit 105K and the transfer roller 108.

The fixing unit 109 performs heating and pressurization for the paper sheet P with the image transferred thereto. The image transferred to the paper sheet P is thus fixed. The fixing unit 109 includes a heating unit 110 and a pressurizing roller 111, which face each other.

The heating unit 110 is, for example, a roller including a heat source configured to heat the heating unit 110. The heat source is, for example, a heater. The roller heated by the heat source heats the paper sheet P. The pressurizing roller 111 pressurizes the paper sheet P passing between the pressurizing roller 111 and the heating unit 110.

The heating unit 110 may include an endless belt suspended on a plurality of rollers. For example, the heating unit 110 includes a plate-shaped heat source, an endless belt, a belt conveyance roller, a tension roller, and a press roller. The endless belt is, for example, a film-like member. The belt conveyance roller drives the endless belt. The tension roller applies a tension to the endless belt. An elastic layer is formed on the surface of the press roller. In the plate-shaped heat source, the heat generator side is brought into contact with the inside of the endless belt and pressed in the direction of the press roller, thereby forming a fixing nip of a predetermined width with respect to the press roller. Since the plate-shaped heat source heats while forming the nip region, the response during energization is higher than in a case of a heating method using a halogen lamp.

In the endless belt, for example, a silicone rubber layer having a thickness of 200 μm is formed outside an SUS (steel use stainless) base material having a thickness of 50 μm or polyimide that is a heat-resistant resin having a thickness of 70 μm, and the outermost periphery is covered with a surface protection layer of (PFA) perfluoroalkoxy alkane or the like. In the press roller, for example, a silicone sponge layer having a thickness of 5 mm is formed on the surface of an iron rod of φ10 mm, and the outermost periphery is covered with a surface protection layer of PFA or the like. In the plate-shaped heat source, for example, a glaze layer and a heating resistance layer are stacked on a ceramic substrate. Also, a heat sink made of aluminum is adhered to the plate-shaped heat source to release extra heat to the opposite side and prevent the substrate from warping. The heating resistance layer is made of, for example, a known material such as TaSiO₂ and divided into a predetermined length and numbers in the main scanning direction.

The discharge tray 112 is a table to which the paper sheet P that has undergone print is discharged.

The double-sided unit 113 sets the paper sheet P to a state for enabling print on the reverse surface. For example, the double-sided unit 113 inverts the paper sheet P by switching back the paper sheet P using a roller or the like.

The scanner 114 reads an image from an original. The scanner 114 is an image reading device configured to read an image from an original. The scanner 114 is, for example, an optical reduction type image reading device including an imaging element such as a CCD (charge-coupled device) image sensor. Also, the scanner 114 may be a CIS (contact image sensor) type image reading device including an imaging element such as a CMOS (complementary metal-oxide-semiconductor) image sensor.

The document feed device 115 is also called, for example, an ADF (auto document feeder) or the like. The document feed device 115 conveys originals placed on an original tray one after another. The scanner 114 reads an image from the conveyed original. The document feed device 115 may include a scanner configured to read an image from the reverse surface of the original.

The control panel 116 is a device to be operated by the operator (user) of the image forming apparatus 100. The control panel 116 includes a display unit (display device) 1161 and an operation unit (operation device) 1162. The display unit 1161 is a display device that displays a guidance, operation buttons, and the like. The display unit 1161 is, for example, a display such as a liquid crystal display or an organic EL display. The operation unit 1162 is an input unit (input device) with which the user inputs information. The operation unit 1162 is formed by, for example, a touch panel, buttons, and the like. In this embodiment, the control panel 116 includes a display device with a touch panel as the display unit 1161 and the operation unit 1162.

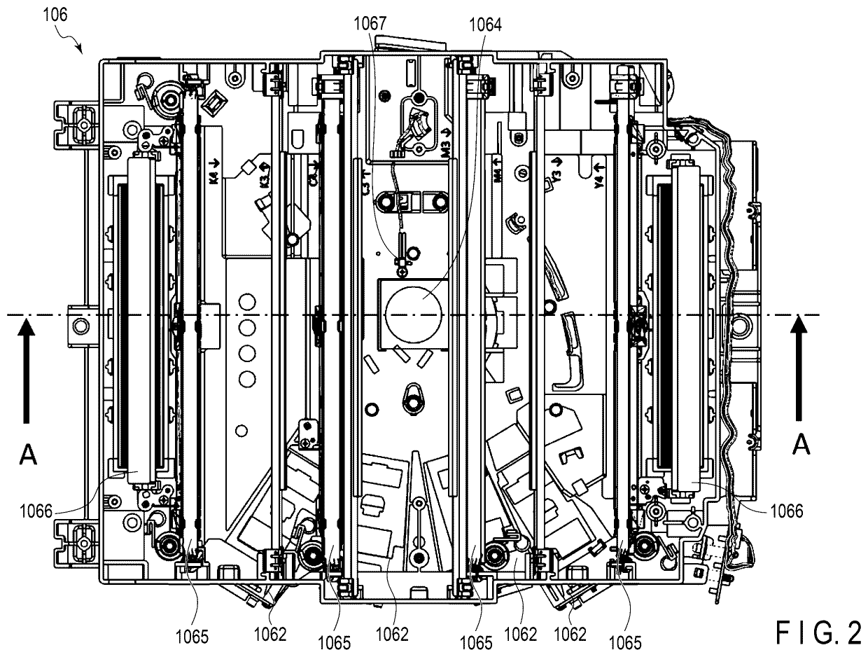

The configuration of the exposure device (exposure unit) 106 in the image forming apparatus 100 according to the embodiment will be described next. FIGS. 2, 3, and 4 are views showing an example of the configuration of the exposure device 106 in the image forming apparatus 100 according to the embodiment.

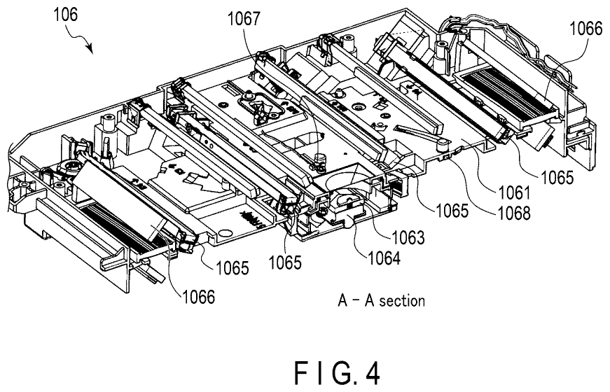

FIG. 2 is a plan view showing an example of the exposure device 106 in the image forming apparatus 100 according to the embodiment. FIG. 3 is a bottom view showing an example of the exposure device 106 in the image forming apparatus 100 according to the embodiment. FIG. 4 is a sectional perspective view showing an example of the exposure device 106 in the image forming apparatus 100 according to the embodiment.

As shown in FIGS. 2, 3, and 4, the exposure device 106 includes a housing 1061, a laser unit 1062, a polygon mirror 1063, a polygon motor 1064, a mirror 1065, a lens 1066, a first thermistor (first temperature sensor) 1067, and a second thermistor (second temperature sensor) 1068,

The housing 1061 is a housing that stores the laser unit 1062, the polygon mirror 1063, the polygon motor 1064, the mirror 1065, the lens 1066, the first thermistor 1067, and the second thermistor 1068. The housing 1061 supports the laser unit 1062, the polygon mirror 1063, the polygon motor 1064, the mirror 1065, the lens 1066, the first thermistor 1067, and the second thermistor 1068. The housing 1061 is made of, for example, a resin.

The exposure device 106 includes, as the laser unit 1062, a laser unit 1062C, a laser unit 1062M, a laser unit 1062Y, and a laser unit 1062K. The laser units 1062C, 1062M, 1062Y, and 1062K correspond to the image forming units 105C, 105M, 105Y, and 105K, respectively. Each laser unit 1062 radiates a laser beam. Each laser unit 1062 controls emission of the laser beam in accordance with a control signal according to the image to be formed by the corresponding image forming unit 105. For example, each laser unit 1062 modulates the laser beam in accordance with a control signal according to image data.

The polygon mirror 1063 reflects the laser beam radiated from each laser unit 1062. The polygon mirror 1063 is rotated by the polygon motor 1064, thereby polarizing and scanning the laser beam. The polygon motor 1064 is a motor that rotates the polygon mirror 1063. The polygon motor 1064 generates heat when rotating the polygon mirror 1063 and can therefore be a heat source in the exposure device 106.

The mirror 1065 and the lens 1066 are optical elements configured to cause the laser beam to scan on the photosensitive drum of each image forming unit 105. For example, the mirror 1065 is provided such that its position or angle with respect to the housing 1061 can be adjusted.

The first thermistor 1067 is an example of a temperature sensor (temperature detection unit) that detects the temperature near the center portion (first portion) in the exposure device 106. The first thermistor 1067 outputs a signal indicating the measured temperature. In the configuration example shown in FIGS. 2, 3, and 4 to be described later, the first thermistor 1067 is installed near the polygon motor 1064 at the center portion of the housing 1061.

The second thermistor 1068 is an example of a temperature sensor (temperature detection unit) that detects the temperature near an end portion (second portion) in the exposure device 106. The second thermistor 1068 outputs a signal indicating the measured temperature. The second thermistor 1068 detects the temperature of the second portion farther from the polygon motor 1064 than the first portion in the exposure device 106. In the example shown in FIGS. 2, 3, and 4, the second thermistor 1068 is installed near the intermediate position between the end of the housing 1061 and the polygon motor 1064. In this case, the second thermistor 1068 is installed in a place more distant from the polygon motor 1064 than the first thermistor 1067.

An environment sensor 211 and dump heaters 221 and 222, which are installed in the image forming apparatus 100 according to the embodiment, will be described next.

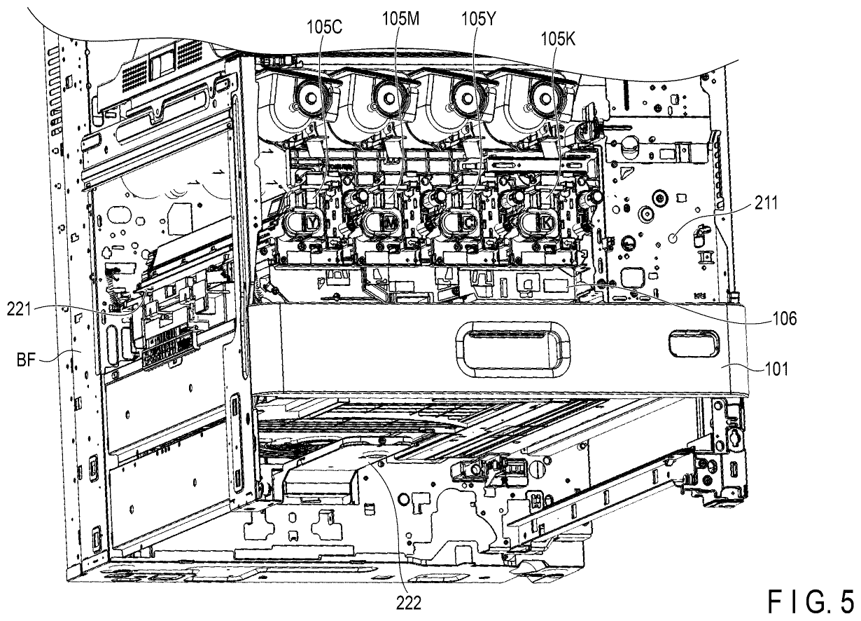

FIG. 5 is a view showing an example of installation of the environment sensor 211 and the dump heaters 221 and 222 in a main body frame (housing) BF of the image forming apparatus 100 according to the embodiment.

The environment sensor 211 includes a sensor that detects the temperature in the installation environment of the image forming apparatus 100. The environment sensor 211 is arranged at a position where the temperature in the housing BF of the image forming apparatus 100 can be detected. In the configuration example shown in FIG. 5, the environment sensor 211 is installed at a position apart from the dump heaters 221 and 222. The environment sensor 211 is arranged such that it is hardly affected by a local temperature increase caused by heat generated by the dump heaters 221 and 222.

The dump heaters 221 and 222 are heaters configured to prevent dew condensation on paper sheets in the housing BF or on the photosensitive drums in the image forming units 105. The dump heaters 221 and 222 operate in a case where the main power supply of the image forming apparatus 100 is off (to be referred to as power-off hereinafter) and the temperature is lower than a set temperature. For example, the dump heaters 221 and 222 each have a configuration in which a heater is connected to a thermostat that operates at the set temperature or less in the power-off state. In each of the dump heaters 221 and 222, if the thermostat operates at the set temperature or less, a current flows to the heater to heat the periphery of the heater.

To prevent dew condensation on paper sheets and the photosensitive drums, the dump heaters 221 and 222 are arranged near the paper feed cassette and the photosensitive drums. For example, the dump heater 221 is arranged near the image forming unit 105 with the photosensitive drum in the configuration example shown in FIG. 5. In the image forming apparatus 100 having the structure of the electrophotographic type printer, the exposure device 106 is arranged near the photosensitive member. For this reason, the dump heater 221 configured to prevent dew condensation on the photosensitive drum is arranged near the exposure device 106.

Also, in the configuration example shown in FIG. 5, the dump heater 222 is arranged near the paper feed tray (paper feed cassette) 101 storing paper sheets. In the configuration shown in FIGS. 1 and 5, the exposure device 106 is arranged on the upper side of the paper feed tray 101 storing paper sheets. In the image forming apparatus 100 with this configuration, the dump heater 222 configured to prevent dew condensation on paper sheets is also arranged near the exposure device 106.

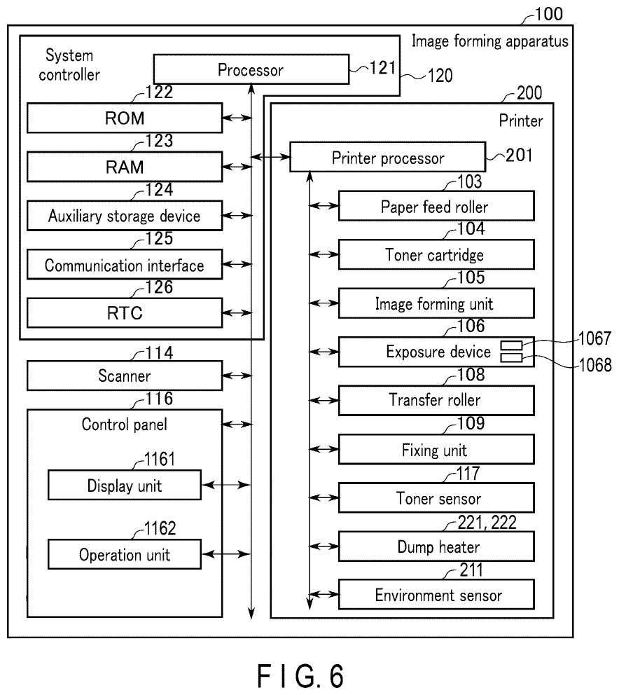

The configuration of a control system in the image forming apparatus 100 according to the embodiment will be described next. FIG. 6 is a block diagram showing an example of the configuration of the control system in the image forming apparatus 100 according to the embodiment.

In the configuration example shown in FIG. 6, the image forming apparatus 100 includes a system controller 120, the scanner 114, the control panel 116, and a printer 200. The system controller 120 includes a processor 121, a ROM (read-only memory) 122, a RAM (random-access memory) 123, an auxiliary storage device 124, a communication interface 125, an RTC (real-time clock) 126, the scanner 114, the control panel 116, and the printer 200.

The processor 121 corresponds to the central section of a computer that performs processing such as operations and control necessary for the operation of the image forming apparatus 100. To implement various kinds of functions of the image forming apparatus 100, the processor 121 controls the units based on programs such as system software, application software, and firmware stored in the ROM 122, the auxiliary storage device 124, or the like.

The processor 121 is, for example, a CPU (central processing unit), an MPU (micro processing unit), an SoC (system on a chip), a DSP (digital signal processor), a GPU (graphics processing unit), an ASIC (application specific integrated circuit), a PLD (programmable logic device), or an FPGA (field-programmable gate array). Alternatively, the processor 121 may be a combination of some of these.

The ROM 122 corresponds to the main storage device of the computer including the processor 121 as the center. The ROM 122 is a nonvolatile memory exclusively used to read data. The ROM 122 stores the above-described programs. Also, the ROM 122 stores data or various kinds of set values used by the processor 121 to perform various kinds of processing.

The RAM 123 corresponds to the main storage device of the computer including the processor 121 as the center. The RAM 123 is a memory used to read and write data. The RAM 123 is used as a so-called work area that temporarily stores data to be used by the processor 121 to perform various kinds of processing.

The auxiliary storage device 124 corresponds to the auxiliary storage device of the computer including the processor 121 as the center. The auxiliary storage device 124 is, for example, an HDD (hard disk drive), an SSD (solid state drive), or the like. The auxiliary storage device 124 stores programs in some cases. Also, the auxiliary storage device 124 stores data used by the processor 121 to perform various kinds of processing, data generated by processing of the processor 121, or various kinds of setting information. For example, the auxiliary storage device 124 is a memory that stores, as various kinds of setting information, an execution condition for the guidance of image misalignment (a threshold for the difference between the environmental temperature and the temperature of the exposure device), a guidance execution time, a guidance end time, and the like.

Note that the image forming apparatus 100 may include an interface to which a storage medium such as a memory card or a USB (universal serial bus) memory can be inserted, in place of the auxiliary storage device 124 or in addition to the auxiliary storage device 124.

The programs stored in the ROM 122 or the auxiliary storage device 124 include programs configured to execute processing to be described later. As an example, for the image forming apparatus 100, the programs are stored in the ROM 122 or the auxiliary storage device 124 and, in this state, transferred to the administrator of the image forming apparatus 100, or the like. For the image forming apparatus 100, the programs may be transferred to the administrator or the like without being stored in the ROM 122 or the auxiliary storage device 124.

Also, the programs configured to execute processing to be described later may be written to the ROM 122 or the auxiliary storage device 124 by an operation of the administrator or a service person. Transfer of the programs can be implemented by, for example, recording these in a removable storage medium such as a magnetic disk, a magnetooptical disk, an optical disk or a semiconductor memory or downloading these via a network or the like.

The communication interface 125 is an interface used by the image forming apparatus 100 to communicate via a network or the like. The communication interface 125 is connected to a terminal device operated by the user.

The RTC 126 is a circuit incorporating a clock or a clock function.

Note that the system controller 120 may include an interface connected to a display device and an operation device, which are external devices. In this case, the processor 121 may display the guidance of image misalignment to be described later on the display device that is an external device connected via the interface.

The printer 200 prints an image on the image formation medium (paper sheet) P based on image data. In the configuration example shown in FIG. 6, in the printer 200, the paper feed roller 103, the toner cartridge 104, the image forming unit 105, the exposure device 106, the transfer roller 108, the fixing unit 109, the toner sensor 117, the environment sensor 211, and the dump heaters 221 and 222 are connected to the printer processor 201. However, the environment sensor 211 and the dump heaters 221 and 222 may be connected to the processor 121 of the system controller 120 without interposing the printer processor 201.

To implement a print function, the printer processor 201 performs processing such as operations and control necessary for the print operation of the image forming apparatus 100. The printer processor 201 performs processing such as operations and control necessary for the print operation based on instructions from the processor 121 and various kinds of programs. Also, the printer processor 201 outputs a processing result and the like to the processor 121.

Note that the various kinds of programs may be stored in a storage unit such as the ROM 122 or the auxiliary storage device 124 or may be installed in the circuit of the printer processor 201. Also, a storage unit provided in the printer 200 may store the various kinds of programs. The printer processor 201 is, for example, a CPU, an MPU, an SoC, a DSP, a GPU, an ASIC, a PLD, or an FPGA.

Position deviation correction (color misalignment correction) for correcting image misalignment in the image forming apparatus 100 according to the embodiment will be described next.

In the image forming apparatus 100, the exposure position may deviate in the exposure device 106 because of a small deformation caused by a variation in the temperature state, or the like. The image forming apparatus 100 has a function of executing position deviation correction for correcting image misalignment caused by the deviation of the exposure position or the like by the exposure device 106.

In the image forming apparatus 100, images (color toner images) formed by the plurality of image forming units 105 using a plurality of color toners are overlaid, thereby generating a color image. Hence, the image forming apparatus 100 needs to adjust misalignment of the image of each color in color print. The position deviation correction in color print is also called color misalignment correction (color registration). The color misalignment correction is executed under the control of the processor 121 or the printer processor 201 when executing color print.

For example, as color misalignment correction, the processor 121 forms, on the transfer belt 107, a predetermined pattern used to measure the misalignment of the image of each color formed by the toner of the color. For the image of each color, the processor 121 detects the deviation amount from an ideal position (reference position) based on the predetermined pattern on the transfer belt 107. The processor 121 changes the timing of exposure by the exposure device 106, or the like based on the deviation amount, thereby correcting the position deviation of the image of each color. More specifically, the processor 121 calculates the relative position deviation of the image of each color between the conveyance direction and the scanning direction from the read result of the predetermined pattern. Thus, the processor 121 adjusts the timing of exposure for forming the image of each color in accordance with the calculated position deviation such that the image patterns of the colors (four colors) are overlaid.

Upon detecting a state in which a predetermined position deviation correction execution condition is satisfied, the image forming apparatus 100 executes position deviation correction (color misalignment correction). The position deviation correction execution condition is set for the temperature in the exposure device 106. For example, the image forming apparatus 100 is set to execute position deviation correction in accordance with the change of the temperature in the exposure device 106, which is detected by the first thermistor 1067 and the second thermistor 1068. Also, the image forming apparatus 100 executes position deviation correction in the activation operation executed in turning on the main power supply. Alternatively, the image forming apparatus 100 may be set to execute position deviation correction when executing color print for the first time after the activation operation. In this embodiment, the image forming apparatus 100 executes position deviation correction in the activation operation.

The influence of on/off of the dump heaters 221 and 222 during power-off on the exposure device 106 in the image forming apparatus 100 will be described next.

In this embodiment, power-off is a state in which the main power supply of the image forming apparatus 100 is off. The image forming apparatus 100 in the power-off state is connected to an external power supply but is in a state (operation stop state) in which various kinds of operations (jobs) such as print and scan are stopped and even an operation instruction other than an operation instruction for turning on the main power supply is not accepted. The dump heaters 221 and 222 are connected such that power from the external power supply can be supplied to these even in the power-off state. For this reason, although the image forming apparatus 100 does not accept various kinds of operations, the dump heaters 221 and 222 can operate. The period of the power-off state is also called an operation stop period. The image forming apparatus 100 during power-off executes activation processing in accordance with an instruction (activation instruction) for turning on the main power supply. The image forming apparatus 100 can execute a job such as print or scan after the activation processing.

In the configuration example shown in FIG. 5, the dump heaters 221 and 222 are arranged near the photosensitive member and the paper feed cassette. If the dump heaters 221 and 222 are turned on during power-off, not only the photosensitive member and the paper feed cassette but also the exposure device 106 is heated. The state of the exposure device 106 may change even after the activation operation depending on whether the dump heaters 221 and 222 are turned on during power-off. In the exposure device 106, the exposure position may change due to small deformation according to the temperature distribution in the housing 1061, and image misalignment (color misalignment) may occur. That is, in the image forming apparatus 100, the state of image misalignment after the activation operation may vary depending on whether the dump heaters 221 and 222 are turned on during power-off.

The change of the state after activation in the image forming apparatus 100 according to the embodiment will be described next.

In the image forming apparatus 100, the occurrence state of image misalignment may change depending on whether the dump heaters 221 and 222 are turned on during power-off before activation. Here, as an example of the operation of the image forming apparatus 100, assume that the main power supply is turned on to set a print operation enable state in the daytime, and the main power supply is turned off to stop the print operation at night. In the image forming apparatus 100 under this operation, the state of image misalignment after activation changes depending on whether the dump heaters 221 and 222 operate during the power-off period (operation stop period) at night.

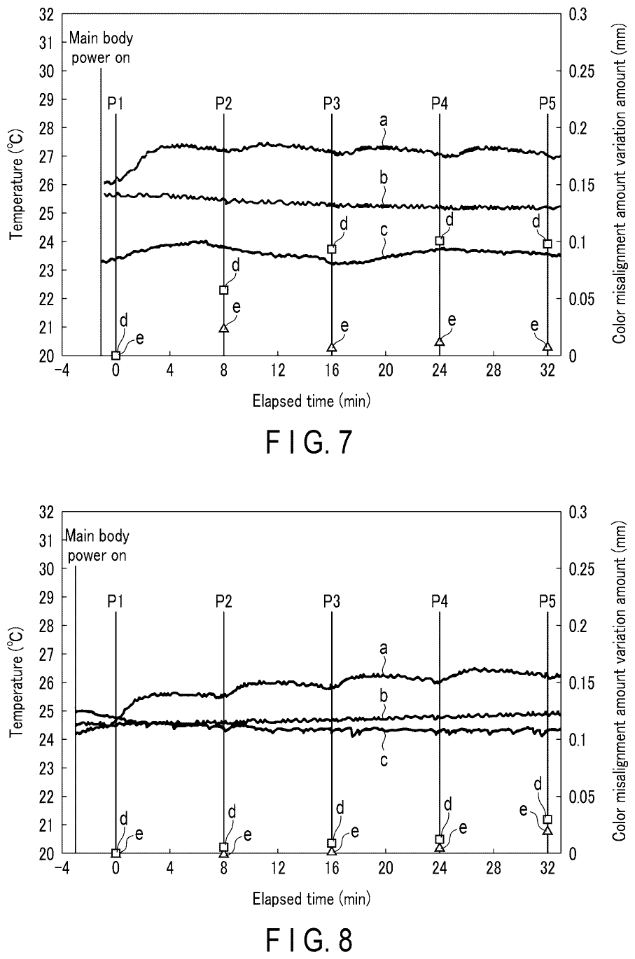

FIGS. 7 and 8 are views each showing the temperature of each portion and the measured value of image misalignment in a case where the image forming apparatus 100 activated from the power-off state (operation stop period) executes print processing at a specific print interval.

FIG. 7 is a view showing the temperature of each portion and the measured value of image misalignment after activation in a case where the dump heaters 221 and 222 operate (are turned on) (a case of heater-on) during the operation stop period. FIG. 8 is a view showing the temperature of each portion and the measured value of image misalignment after activation in a case where the dump heaters 221 and 222 do not operate (are not turned on) (a case of heater-off) during the operation stop period.

Note that in FIGS. 7 and 8, the operation stop period is 14 hours, the print interval is 8 min, and as the contents of print processing, color print is performed for two paper sheets in A3 size. FIGS. 7 and 8 each show a measurement result in a case where activation processing (activation operation) is executed in accordance with power-on after the operation stop period and position deviation correction is executed immediately before the first print. The dump heaters 221 and 222 are assumed to be turned off at the same time as power-on.

FIGS. 7 and 8 show a detected temperature a of the first thermistor 1067 and a detected temperature b of the second thermistor 1068 as the temperature in the exposure device (exposure unit) (the temperature in the housing 1061 of the exposure device 106). Also, FIGS. 7 and 8 show a detected temperature c of the environment sensor 211 as the environmental temperature. Furthermore, FIGS. 7 and 8 show, as the measured value of image misalignment, the measured value of image misalignment appearing on the paper sheet color-printed by the image forming apparatus 100. In FIGS. 7 and 8, a measured value d of image misalignment in the main scanning direction is indicated by a rectangular point, and a measured value e of image misalignment in the sub-scanning direction is indicated by a triangular point.

First, the temperature in the housing 1061 of the exposure device 106 (the temperature of the exposure device 106) immediately after power-on is compared with the environmental temperature.

Here, the detected temperature a of the first thermistor 1067 is the temperature at the center portion of the housing 1061, which is near the polygon motor 1064 in the exposure device 106. The detected temperature b of the second thermistor 1068 is the temperature at the end portion of the housing 1061, which is apart from the polygon motor 1064 in the exposure device 106. The temperature of the exposure device (exposure unit) may be the detected temperature of one of the first thermistor 1067 and the second thermistor 1068 or may be the average value of the detected temperature of the first thermistor 1067 and the detected temperature of the second thermistor 1068.

In the example shown in FIG. 8, immediately after power-on, the difference between the detected temperature a of the first thermistor 1067, the detected temperature b of the second thermistor 1068, and the detected temperature c of the environment sensor 211 is 1° C. or less. Considering the measurement accuracy of the first thermistor 1067, the second thermistor 1068, and the environment sensor 211, in the example shown in FIG. 8, it can be said that the temperature of the exposure device and the environmental temperature substantially equal immediately after power-on. Hence, in the case where the dump heaters 221 and 222 do not operate (the case of heater-off) during power-off, it can be considered that the temperature of the exposure device and the environmental temperature substantially equal immediately after power-on.

In the example shown in FIG. 7, immediately after power-on, the detected temperature a of the first thermistor and the detected temperature b of the second thermistor are higher than the detected temperature c of the environment sensor 211. It is therefore considered that if the dump heaters 221 and 222 operate during power-off (a case of heater-on), the temperature of the exposure device is higher than the environmental temperature immediately after power-on.

The temperature change of each portion after the start of the print operation will be described next.

In the example shown in FIG. 8, after the print operation is started, both the detected temperature a of the first thermistor 1067 and the detected temperature b of the second thermistor 1068 tend to rise. Each portion whose temperature rises in the housing 1061 tends to physically expand. That is, in the exposure device 106, in a case where the heater is off during power-off, the temperature of the center portion and the end portion of the housing 1061 rises. It is therefore considered that the entire housing 1061 expands. If the entire housing 1061 expands, the deformation amount of the entire housing 1061 is relatively small as compared to a case where the center portion of the housing 1061 expands and the end portion shrinks. As a result, it is considered that, in the exposure device 106, image misalignment is small in print after the activation operation (after position deviation correction before the first print).

In the example shown in FIG. 7, after the start of the print operation, the detected temperature a of the first thermistor tends to rise, and the detected temperature b of the second thermistor tends to lower. It is considered that the detected temperature a of the first thermistor tends to rise because heat is generated by driving the polygon motor 1064 located at the center portion of the housing 1061. It is considered that the detected temperature b of the second thermistor tends to lower because the end portion of the housing 1061 is cooled by the temperature difference from the environmental temperature. It is considered that the heat generated by the polygon motor 1064 is transmitted to the end portion of the housing 1061 but its temperature tends lower because the temperature difference from the environmental temperature is large.

In FIG. 7, image misalignment in print after the activation operation is indicated by a point d and a point e. As shown in FIG. 7, if the heater is turned on during power-off, in print after the activation operation (after first position deviation correction), image misalignment becomes large along with the temperature rise at the center portion of the housing 1061 and the temperature lowering at the end portion. It is considered that the image misalignment occurs if the center portion of the housing 1061 expands due to the temperature rise and the end portion shrinks due to the temperature lowering. If both the expansion of the center portion and the shrinkage of the end portion simultaneously occur, the deformation amount of the entire housing 1061 is relatively large as compared to a case where the entire housing 1061 expands. It is considered that if the deformation amount of the housing 1061 is large, the deviation of the exposure position in the exposure device 106 is large and the misalignment of the image (the image of each color) printed on the medium is large.

Comparing FIGS. 7 and 8, it is apparent that the deformation amount of image misalignment per time is large in a case where the heater is turned on during power-off. In the example shown in FIG. 7, in print at the 8-min interval after the activation operation, the change amount (increase amount) of image misalignment becomes large during the time (16 min) from the first print to the third print. In the example shown in FIG. 7, however, the temperature of the center portion of the housing 1061 rises immediately after the first print and then remains almost constant, and the time-rate change of the temperature of the end portion of the housing 1061 is small.

In the temperature change shown in FIG. 7, it is difficult to set executing position deviation correction under a temperature condition for the temperature difference between the temperature of the center portion and the temperature of the end portion (the temperature difference between the detected temperature of the first thermistor 1067 and the detected temperature of the second thermistor 1068). If setting is done to execute position deviation correction even if the temperature difference between the center portion and the end portion is small, an accurate thermistor is needed, and the print operation is performed slowly because position deviation correction is frequently executed. However, it is assumed that some users can permit image misalignment of a magnitude as shown in FIG. 7. That is, it is considered that, as for the operation of the image forming apparatus 100, it is preferable to cause the user to select whether to execute position deviation correction for the image misalignment as shown in FIG. 7.

The image forming apparatus 100 according to the embodiment has a function of notifying a guidance (alert) of image misalignment to the user upon detecting a situation in which image misalignment as shown in FIG. 7 may occur. For example, if the difference between the temperature of the exposure device and the environmental temperature immediately after power-on is a predetermined value or more, the image forming apparatus 100 displays a guidance of image misalignment on the display unit 1161. Also, the image forming apparatus 100 may display the guidance of image misalignment on the display unit 1161 upon detecting that the dump heaters 221 and 222 operate during the power-off period before power-on.

An operation of guidance processing of image misalignment after the activation operation by the image forming apparatus 100 according to the embodiment will be described next.

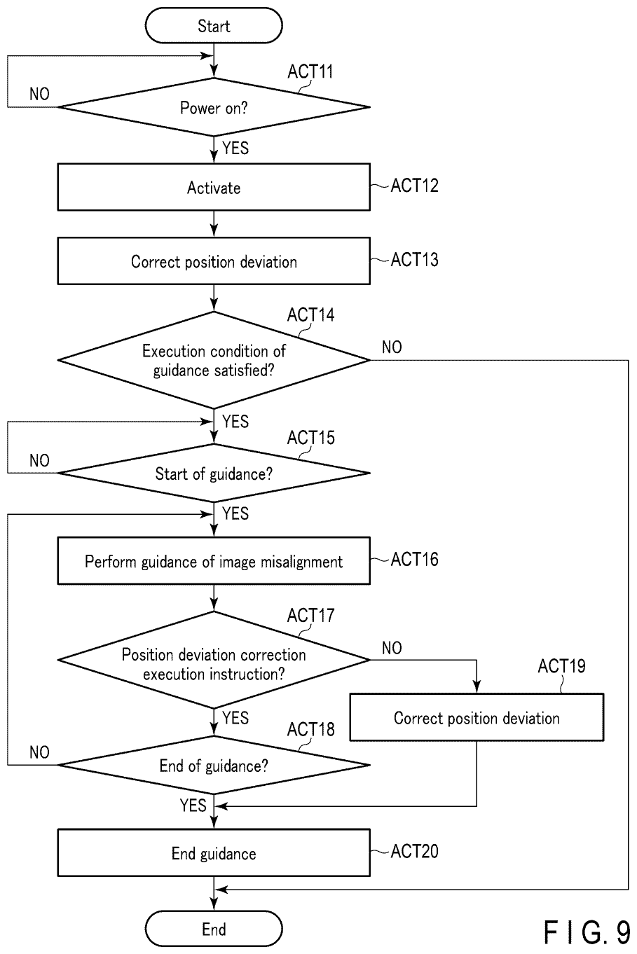

FIG. 9 is a flowchart for explaining an example of the operation of image misalignment guidance processing after the activation operation by the image forming apparatus 100 according to the embodiment.

As described above, in the image forming apparatus 100, if the temperature is a predetermined temperature or less in the power-off state (operation stop period), the dump heaters 221 and 222 operate. If image misalignment may occur after the activation operation due to the operation of the dump heaters 221 and 222 in the power-off state, the image forming apparatus 100 performs processing of displaying a guidance of image misalignment on the display unit 1161.

The processor 121 of the image forming apparatus 100 accepts a power-on signal in the power-off state. For example, if a main power button provided on the image forming apparatus 100 is pressed, the power-on signal is input to the processor 121. If a power-on instruction is input (YES in ACT11), the processor 121 executes the activation operation (ACT12), and executes first position deviation correction before the first print (ACT13).

When performing the activation operation in accordance with power-on, the processor 121 determines whether to perform the guidance of image misalignment after the activation operation (ACT14). For example, the processor 121 determines whether to perform the guidance of image misalignment depending on whether a preset execution condition of the guidance concerning image misalignment is satisfied. The execution condition of the guidance concerning image misalignment is set as a condition to determine whether the dump heaters 221 and 222 operate (on) during power-on (operation stop period).

For example, the processor 121 determines whether the difference between the temperature of the exposure device and the environmental temperature during time from immediately after power-on to the start of the first print is a predetermined threshold or more (guidance execution condition). The predetermined threshold is set in accordance with the heater capacity of the dump heaters 221 and 222, the body structure of the apparatus, the accuracy of the first and second thermistors, and the like. As an example, referring to the measurement result shown in FIG. 7, the predetermined threshold is set to a value close to 2° C.

When calculating the difference between the temperature of the exposure device and the environmental temperature, the processor 121 acquires information indicating the temperature from each sensor immediately after power-on. That is, the processor 121 acquires information indicating the detected temperature from each of the first thermistor 1067, the second thermistor 1068, and the environment sensor 211.

The processor 121 obtains the detected temperature of the environment sensor 211 as the environmental temperature and the detected temperatures of the first thermistor 1067 and the second thermistor 1068 as the temperature of the exposure device. However, the processor 121 may obtain the detected temperature of one of the first thermistor 1067 and the second thermistor 1068 as the temperature of the exposure device, or may obtain the average value of the detected temperature of the first thermistor 1067 and the detected temperature of the second thermistor 1068 as the temperature of the exposure device.

The processor 121 acquires the temperature of the exposure device and the environmental temperature and, after that, calculates the difference value by subtracting the environmental temperature from the temperature of the exposure device, and determines whether the calculated difference value is the predetermined threshold or more.

Note that determining whether to perform the guidance of image misalignment is not limited to determining based on the difference between the temperature of the exposure device and the environmental temperature. For example, it may be determined whether to perform the guidance of image misalignment by detecting whether the dump heaters 221 and 222 operate during power-on. As a detailed example, the image forming apparatus 100 may include a recording unit that records that the dump heaters 221 and 222 are turned on during power-off. In this case, the processor 121 determines whether the dump heaters 221 and 222 operate during power-on based on the recording contents of the recording unit.

Upon determining to perform the guidance of image misalignment (ACT14), the processor 121 determines whether to start the guidance of image misalignment (ACT15). For example, the processor 121 is set to start the guidance of image misalignment if a predetermined guidance start time (for example, 8 to 16 min) elapses after the activation operation (first position deviation correction).

In the example shown in FIG. 7, since position deviation correction is executed immediately before the first print, the variation amount of image misalignment is large in the third print after the activation operation. For this reason, referring to the measurement result shown in FIG. 7, a setting to start displaying the guidance of image misalignment before the third print can be considered. In this case, the guidance start time that is the time elapsed from the activation operation to the guidance start is set to 8 to 16 min.

Upon determining to start the guidance of image misalignment (YES in ACT15), the processor 121 displays the guidance of image misalignment on the display unit 1161 (ACT16). For example, the processor 121 displays the guidance of image misalignment in addition to an operation screen displayed on the display unit 1161. The processor 121 may display a button for instructing execution of position deviation correction om the display unit 1161.

As an example of the guidance (alert) of image misalignment displayed on the display unit 1161, the processor 121 displays that color misalignment (image misalignment) may be larger than usual. Also, as an example of the guidance displayed on the display unit 1161, the processor 121 may display a guidance for recommending position deviation correction. Furthermore, as an example of the guidance displayed on the display unit 1161, the processor 121 may display a guide for guiding to an instruction button for instructing position deviation correction.

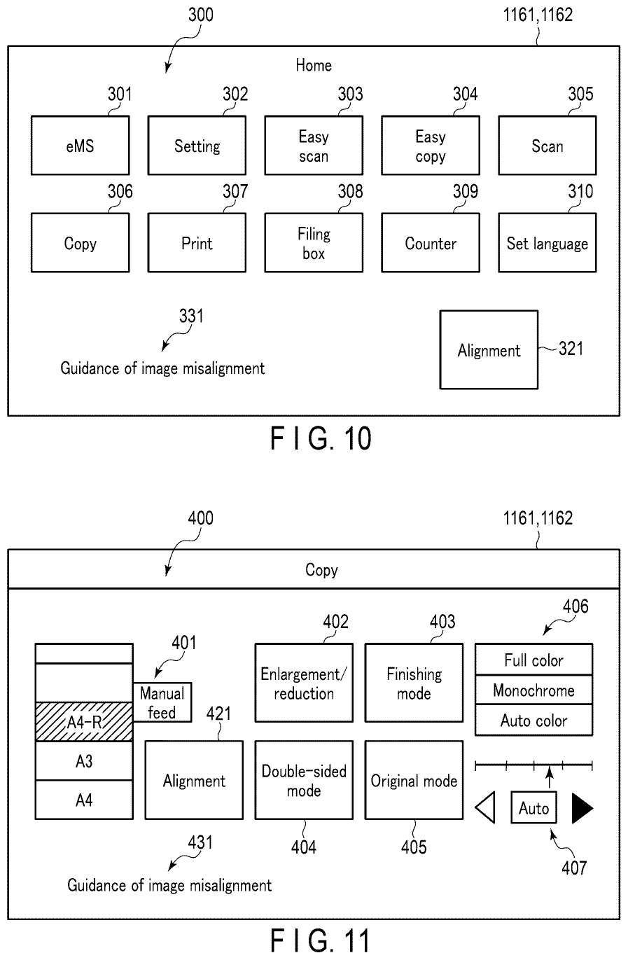

FIGS. 10 and 11 are views showing a display example in which a guidance of image misalignment is displayed on the display unit 1161.

FIG. 10 is a view showing a display example in which the guidance of image misalignment is displayed on a part of a main operation screen (home scree) 300 that the image forming apparatus 100 displays on the display unit 1161 during standby (operation standby).

On the home screen 300 of the display example shown in FIG. 10, an alignment (position deviation correction) button 321 and a guidance (message) 331 of image misalignment are displayed in addition to mode selectin buttons 301, 302, 302, 303, 304, 305, 306, 307, 308, 309, and 310 used to select various kinds of operation modes. As the guidance 331 of image misalignment, a guidance message as described above is displayed. The alignment button 321 is a button for instructing execution of position deviation correction. In the display example shown in FIG. 10, the alignment button 321 is displayed together with the guidance 331 of image misalignment.

FIG. 11 is a view showing a display example in which the guidance of image misalignment is displayed on a part of a copy operation screen 400 that is displayed on the display unit 1161 upon selecting copy as the operation mode.

On the copy operation screen 400 of the display example shown in FIG. 11, an alignment (position deviation correction) button 421 and a guidance (message) 431 of image misalignment are displayed, in addition to mode selection buttons 402, 403, 404, and 405 used to select various kinds of copy modes, a state display portion 401, a color mode display portion 406, and a density display portion 407. As the guidance 431 of image misalignment, a guidance message as described above is displayed. The alignment button 421 is a button for instructing execution of position deviation correction. In the display example shown in FIG. 11 as well, the alignment button 421 is displayed together with the guidance 431 of image misalignment.

In a state in which the guidance of image misalignment is displayed, the processor 121 accepts a position deviation correction execution instruction (ACT17). For example, upon detecting input of an instruction to the alignment button 321 or 421 in the display example shown in FIG. 10 or 11, the processor 121 determines to execute position deviation correction. Upon determining to execute position deviation correction (YES in ACT17), the processor 121 executes position deviation correction (ACT19). The processor 121 executes position deviation correction and then ends the guidance of image misalignment (ACT20).

Also, if there is no position deviation correction execution instruction in the state in which the guidance of image misalignment is displayed (NO in ACT17), the processor 121 determines whether to end the guidance of image misalignment (ACT18). For example, if a guidance end time longer than the guidance start time after the activation operation (first position deviation correction) has elapsed, the processor 121 determines to end the guidance of image misalignment. The guidance end time is set to, for example, 30 to 40 min. In this case, if the guidance start time is 8 min, and the guidance end time is 40 min, the display unit 1161 displays the guidance of image misalignment for 32 in from the start of guidance.

Upon determining that it is not the timing to end the guidance of image misalignment (NO in ACT18), the processor 121 returns to ACT16 and continues the guidance of image misalignment on the display unit 1161. Also, upon determining to end the guidance of image misalignment (YES in ACT18), the processor 121 ends the guidance of image misalignment displayed on the display unit 1161 (ACT20).

As described above, the image forming apparatus according to the embodiment determines whether the difference value obtained by subtracting the environmental temperature from the temperature of the exposure device during time from immediately after power-on to the start of print is a predetermined threshold or more. If the calculated difference value is the predetermined threshold or more, the image forming apparatus displays the guidance of image misalignment on the display unit together with the operation screen after the elapse of a predetermined time from activation.

Also, the image forming apparatus according to the embodiment determines whether the dump heaters operate during power-off (operation stop period) before power-on. Upon determining that the dump heaters operate during power-off (operation stop period) before power-on, the image forming apparatus displays the guidance of image misalignment on the display unit together with the operation screen after the elapse of a predetermined time from activation.

According to the image forming apparatus of the embodiment, it is possible to notify the user that image misalignment may occur in print after activation due to the operation of the dump heaters during power-off. Also, according to the image forming apparatus of the embodiment, position deviation correction can be recommended for the user as the guidance of image misalignment. As a result, it is possible to provide print with image misalignment suppressed for a user who wants high-quality color print without color misalignment by causing him/her to select execution of position deviation correction for image misalignment after activation. In addition, it is possible to provide, for a user who permits small color misalignment, high-speed print in which position deviation correction for image misalignment after activation is omitted to reduce time required for position deviation correction.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a plurality of image forming units each configured to form an image by developing a latent image formed on a photosensitive member by a developing agent supplied to the image forming unit;
an exposure unit configured to output light to form the latent image on the photosensitive member in each of the plurality of image forming units;
a transfer unit configured to overlay a plurality of images that the plurality of image forming units have developed by the developing agent and transfer the images to a medium; and
a processor configured to, if a difference between an environmental temperature and a temperature in the exposure unit during a time from a start of activation to a start of image formation satisfies a predetermined condition, display, on a display device, a guidance to notify misalignment of each image that the transfer unit transfers to the medium after a predetermined guidance start time has elapsed from an activation operation.

2. The apparatus according to claim 1, further comprising:
an environment sensor configured to measure the environmental temperature; and
a temperature sensor configured to measure the temperature in the exposure unit,
wherein the predetermined condition is a condition that a difference value obtained by subtracting a detected temperature of the environment sensor from a detected temperature of the temperature sensor is not less than a predetermined temperature.

3. The apparatus according to claim 1, further comprising:
a heater provided in a housing of the image forming apparatus and configured to generate heat at not more than a predetermined temperature.

4. The apparatus according to claim 3, wherein the heater is provided near the plurality of image forming units.

5. The apparatus according to claim 3, further comprising:
a paper feed cassette configured to store a paper sheet to which the images formed by the plurality of image forming units are transferred,
wherein the heater is provided near the paper feed cassette.

6. The apparatus according to claim 1, wherein the processor is configured to display, on the display device, a message for recommending execution of position deviation correction as the guidance.

7. The apparatus according to claim 1, wherein the processor is configured to display, on the display device, a message for guiding to an operation instruction of position deviation correction as the guidance.

8. The apparatus according to claim 1, wherein the processor is configured to display, on the display device, a message for notifying that image misalignment may be large as the guidance.

9. The apparatus according to claim 1, wherein the processor is configured to display, on the display device, a button for instructing execution of position deviation correction as the guidance.

10. The apparatus according to claim 9, wherein if position deviation correction is executed in accordance with an instruction input to the button, the processor is configured to end the guidance.

11. The apparatus according to claim 1, wherein if a guidance end time longer than the guidance start time after the activation operation has elapsed, the processor is configured to end the guidance.

12. An image forming apparatus comprising:
a plurality of image forming units each configured to form a developing agent image by developing a latent image formed on a photosensitive member by a developing agent;
an exposure unit configured to output light to form the latent image on the photosensitive member in each of the plurality of image forming units;
a transfer unit configured to transfer, to a medium, an image formed by overlaying a plurality of developing agent images formed by the plurality of image forming units;
a heater provided in a housing of the image forming apparatus and configured to generate heat at not more than a predetermined temperature; and
a processor configured to, if the heater is on during an operation stop period before activation, display, on a display device, a guidance to notify misalignment of each image that the transfer unit transfers to the medium after a predetermined guidance start time has elapsed from an activation operation.

13. The apparatus according to claim 12, wherein the heater is provided near the plurality of image forming units.

14. The apparatus according to claim 12, further comprising:
a paper feed cassette configured to store a paper sheet to which the images formed by the plurality of image forming units are transferred,
wherein the heater is provided near the paper feed cassette.

15. The apparatus according to claim 12, wherein the processor is configured to display, on the display device, a message for recommending execution of position deviation correction as the guidance.

16. The apparatus according to claim 12, wherein the processor is configured to display, on the display device, a message for guiding to an operation instruction of position deviation correction as the guidance.

17. The apparatus according to claim 12, wherein the processor is configured to display, on the display device, a message for notifying that image misalignment may be large as the guidance.

18. The apparatus according to claim 12, wherein the processor is configured to display, on the display device, a button for instructing execution of position deviation correction as the guidance.

19. The apparatus according to claim 18, wherein if position deviation correction is executed in accordance with an instruction input to the button, the processor is configured to end the guidance.

20. The apparatus according to claim 12, wherein if a guidance end time longer than the guidance start time after the activation operation has elapsed, the processor is configured to end the guidance.
